(19) United States
(12) Patent Application Publication
(10) Pub. No.: US 2005/0136782 A1
(43) Pub. Date: Jun. 23, 2005

(54) White light emitting diode and method for fabricating the same

(76) Inventor: Hsing Chen, Hsinchu City (TW)

Correspondence Address: Chun-Ming Shih, 4331 Stevens Battle Lane, Fairfax, VA, 22033, US

(21) Appl. No.: 10/879,029

(22) Filed: Jun. 30, 2004

(30) Foreign Application Priority Data
Dec. 22, 2003 (TW) 092136347

(51) Int. Cl. H01J 9/00; H01J 9/24

(52) U.S. Cl. 445/24

(57) ABSTRACT

A white light emitting diode including CaMoO₄:Eu red fluorescent powder and YAG yellow fluorescent powder to the blue LED chip is disclosed. Therefore, the white light can deliver an excellent red color signal and has a good color rendering. This white light source creates a fresh and brilliant visible appearance when being radiated onto a colored object.

### BACKGROUND OF THE INVENTION

1. Field of the Invention

The present invention relates to a white light emitting diode (LED), and more particularly, to a method by adding a yellow and a red fluorescent powders on a blue LED so as to obtain a white LED with improved color rendering thereby freshening the resultant color exhibition thereof.

2. Description of the Prior Art

The white LED is well known as disclosed in U.S. Pat. No. 5,998,925 of NICHIA Company. It is characterized that the blue and yellow lights are mixed to result in a white color by adding yttrium-aluminum-garnet (YAG) yellow fluorescent powder on the blue LED chip. There are only two wavelengths contained in this white color source, i.e. the blue and yellow wavelengths as shown on an optical spectrum graph of FIG. 1. Different from natural white color, the artificial white color is composed of wavelengths of three original colors red, green, and blue. In the case of the above mentioned NICHIA patent is applied for the back light source of a color TFT-LCD, the overall color exhibited on the LCD display board is found to be substantially weak and lack of freshness against incoming red color signal. It is an evidence that the white LED produced according to NICHIA technology is lacking the red color. In the case such white LED is applied for the flash light of a digital camera, an dominant blue or yellow colored photograph will be obtained from this camera.

In view of the disadvantage of the white LED provided by NICHIA without the red light wave, U.S. Pat. No. 6,351,069 of LUMILEDS LIGHTING Company discloses an improved YAG yellow fluorescent powder. Pr (YAG:Ce,Pr) is added to the original YAG:Ce fluorescent powder so as to produce a wave peak at the position of 600 nm wave length. The drawback of lacking the red color signal is inherent to the YAG fluorescent powder. This progressively improved optical spectrum graph of a two wavelength white LED is shown in FIG. 2, it obviously has a problem needed to be solved that the signal still remains to be intensified for the reason that the 600 nm wavelength is corresponding to the orange color light instead of red color light. Moreover, there is another solution to add a red color fluorescent material such as CaS:Eu or SrS:Eu in the YAG yellow fluorescent powder. However, the red color fluorescent powders CaS:Eu or SrS:Eu is water soluble sulfide and is easy to chemically react with the Ag or Cu materials at the substrate into silver sulfate or copper sulfate. As a result, the reliability and brightness of the LED will be affected substantially.

Being studied white LED in the related field, the inventor(s) of the present invention has (have) continued to put forth every effort for years by consistent research and experimentation attempting to discover a remedy to supplement the inherent drawback of the prior techniques described above, and has succeeded obtain an improved with LED and method for fabricating the same.

### SUMMARY OF THE INVENTION

The present invention is to provide an improved white LED including an oxide red fluorescent powder which can be excited by a blue light.

In one aspect, the mixture of a red and a yellow fluorescent powders is applied to a blue LED chip, then using the blue light emitted from the blue LED chip to excite the yellow and red fluorescent powders added on the surface of the blue LED chip so as to produce a resultant white light. The innovative white light can deliver an excellent red color signal and has a good color rendering. This white color light source creates a fresh and brilliant visible feeling when being radiated onto a colored object.

The discovery of the oxide red fluorescent material is the key of the present invention with which a red light of 612 nm wave length can be delivered when the fluorescent powder is excited by a blue light in 460˜470 nm wave length range.

Practically, by adding a small amount of red fluorescent powder in the yellow fluorescent powder, and after being uniformly mixed, the mixture is further mixed with a transparent epoxy and then the resultant product is coated on the surface of a blue LED chip. The mixed fluorescent powder is excited by a blue light so as to produce a yellow and a red fluorescent light waves which then mingled with parts of blue light generated by the blue LED chip to form a desired white light.

### BRIEF DESCRIPTION OF THE DRAWINGS

The drawings disclose an illustrative embodiment of the present invention which serves to exemplify the various advantages and objects hereof, and are as follows:

FIG. 1 is an optical spectrum graph of a two wavelength white LED according to a conventional technique.

FIG. 2 is an optical spectrum graph of an improved two wavelength white LED according to another conventional technique.

FIG. 3 is an absorption optical spectrum graph of a red fluorescent powder according to the present invention.

FIG. 4 is a radiation optical spectrum graph of a red fluorescent powder according to the present invention.

FIG. 5 is an absorption optical spectrum graph of YAG fluorescent powder.

FIG. 6 is a radiation optical spectrum graph of YAG fluorescent powder.

FIG. 7 is a schematic structure of the white LED fabricated according to the present invention.

FIG. 8 is an actual optical spectrum graph of the white LED fabricated according to the present invention.

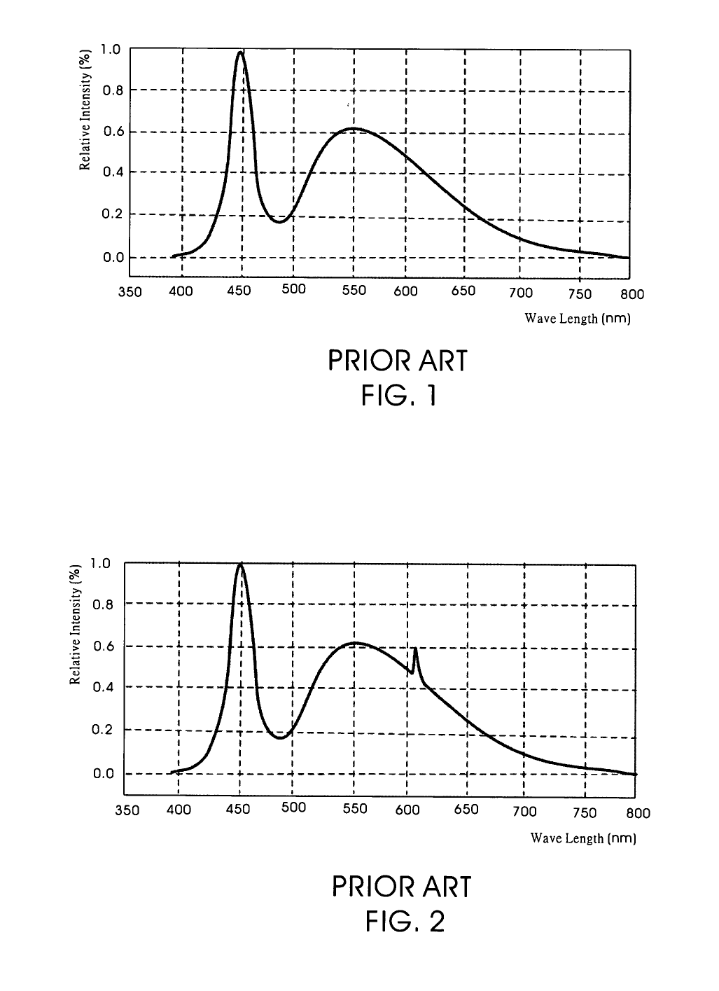

### DETAILED DESCRIPTION OF THE PREFERRED EMBODIMENT

The fluorescent materials generally absorb those lights in the ultra violet range, while the lights in the visible wave range (400˜700 nm) are seldom absorbed except very few materials such as YAG:Ce and etc. However, it is really a hard task to find out oxide red fluorescent material which can be efficiently excited by blue light in 450˜470 nm wavelength range. This is the reason why so few blue light excitable oxide red fluorescent powders have been found up to now except the sulfides CaS:Eu and SrS:Eu.

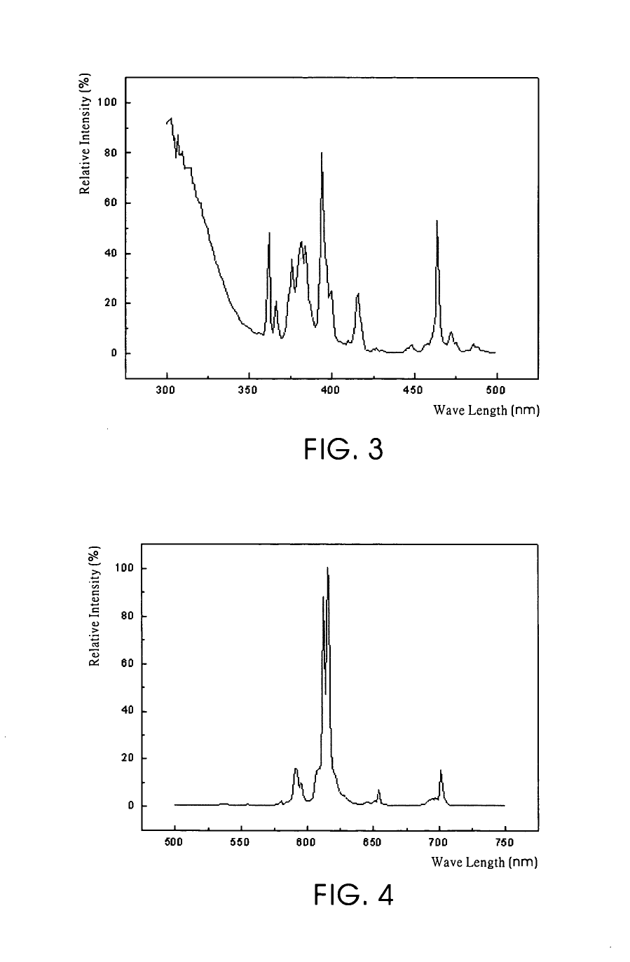

In the present invention, an Eu activated chemical compound Powellite (CaMoO₄:Eu) is employed as the red fluorescent powder which is characterized by having a very narrow (2˜5 nm) absorption wave length. Referring to FIG. 3, the absorption wave peaks appear only at the wavelength λp=464 nm for the blue light wave and λp=394 nm for the purple light wave. In the present invention, wave length λp=464 nm is adopted, in this case, the radiated red color wave length is 612 nm.

Common blue light wavelength varies between 450 nm˜470 nm with which YAG yellow fluorescent powder can be excited and absorbed. Since the width of a half wave height of the blue LED chip is about 30 nm, it is preferably to select λp in the range of 460˜470 nm in order to achieve an optimal light emitting efficiency for YAG yellow fluorescent powder and CaMoO₄:Eu red fluorescent powder.

In the present invention, the wavelength is represented by peak value (λp). As described above, by selecting the blue LED of wave length in 460˜470 nm range, then mixing the mixture of a yellow and a red fluorescent powders with a transparent epoxy, and coating this mixed resultant material directly on the surface of the blue LED chip thereby producing a white light or a white light analogues to that of an incandescent lamp with a low color temperature between 2500˜3500K as shown in FIG. 8.

Generally, it is impossible to provide a light source with a low color temperature for the conventional two wavelength white LED without adding a red fluorescent powder. The present invention includes a red fluorescent powder added to the blue light LED in addition to YAG yellow fluorescent powder. The added fluorescent powder creates a red optical spectrum but not an orange one. This added red fluorescent material is a chemically stable oxide without affecting the quality of the LED product. The excellent color rendering is a unique characteristic that it is very suitable for as applying to the back light source for a LCD panel, or for the flash light of a digital camera, or even for the indoor light source.

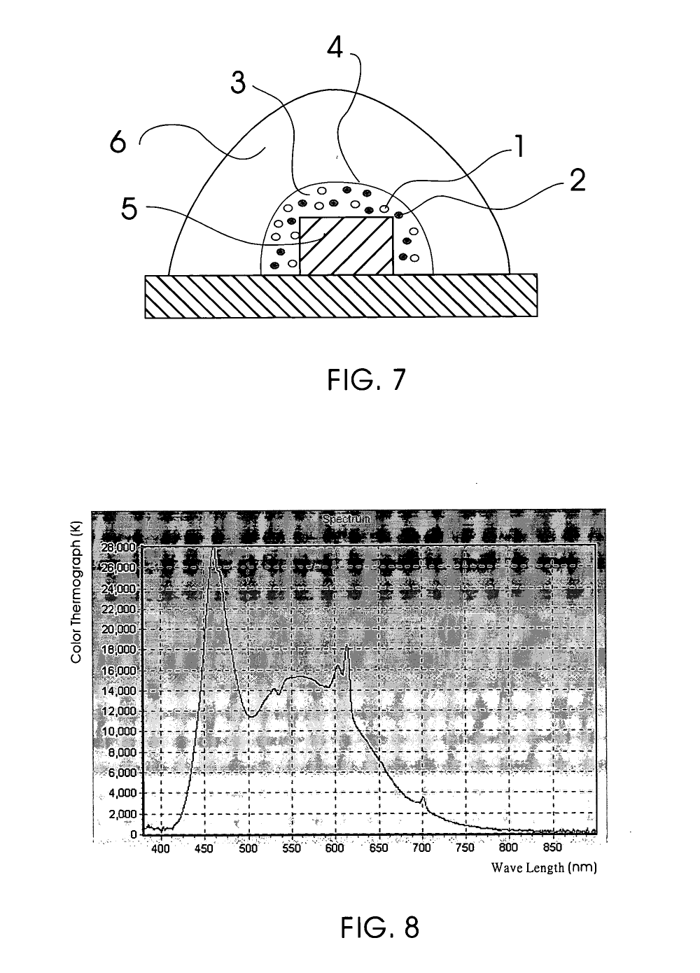

Referring to FIG. 7, the method for fabricating the white LED of the present invention includes the following steps:

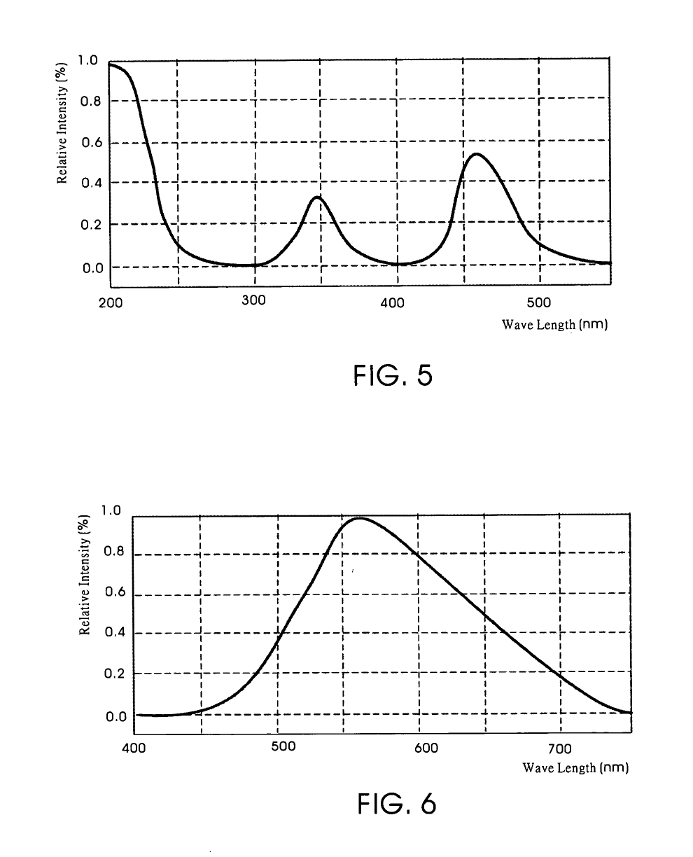

Step 1: Select the yellow fluorescent powder 1 from (Y,Gd)₃Al₅O₁₂:Ce, i.e. YAG fluorescent powder, or (Tb, Y)₃Al₅O₁₂:Ce, i.e. TbAG. The absorption and radiation optical spectrums of the yellow fluorescent powder 1 are respectively shown in FIG. 5 and FIG. 6. Further mare, select the red fluorescent powder 2 from CaMoO₄:Eu. The absorption and radiation optical spectrums of the red fluorescent powder 2 are respectively shown in FIG. 3 and FIG. 4. Mix the yellow fluorescent powder 1 and the red fluorescent powder 2 appropriately with an approximate proportion of 3:1.

Step 2: Mix the uniformly formed yellow and red fluorescent powder mixture obtained from step 1 with a transparent resin 3 such as epoxy or silicon to form a fluorescent resin 4.

Step 3: Coat the fluorescent resin 4 directly on a blue LED chip 5 so as to cover all the surface of the blue LED chip 5.

Step 4: Provide a transparent LED package 6 to be formed into a desired configuration such as a lamp figure by the processes of surface mounting, molding or casting. The optical spectrum graph of the completed white LED product is shown in FIG. 8.

The method for improving white LED characteristics according to the present invention has several advantages that the added red fluorescent powder is a chemically stable (without chemically reacting with the package materials) and heat resistant (above 200° C.) material. On the contrary, conventional CaS:Eu or SrS:Eu is a sulfide materical that absorb the moisture easily and deteriorate the LED. Also, conventional red fluorescent powder is easy to react with Ag contained in the reflection layer of the package material so that the brightness, the quality and the lifetime of the product will be affected.

The prominent feature of the present invention is adding the red fluorescent powder into conventional YAG yellow fluorescent powder so as to control the color temperature of the resultant white light in the good color rendering range of 2500K˜3500K similar to that of the incandescent lamp. According to a test made by the present inventor(s), the actual optical spectrum of the white LED of the present invention is shown in FIG. 8.

Another remarkable feature of the present invention is that the white LED fabricated thereby is well applicable for the back light source of the color TFT and for the flash light of the digital camera to provide excellent color rendering.

The method of the present invention has shown a much better performance of white LED by adding CaMoO₄:Eu red fluorescent powder than the white LED of NICHIA that YAG is added on the blue LED chip in terms of color rendering and the quality of the white LED. The present invention is a high technology innovation and can not be easily made by common skill. Prior to the application for patent, the invention has neither been published or put to public use, nor displayed in an exhibition therefore the present invention is entitled for a patent.

Many changes and modifications in the above described embodiment of the invention can, of course, be carried out without departing from the scope thereof. Accordingly, to promote the progress in science and the useful arts, the invention is disclosed and intended to be limited only by the scope of the appended claims.

1. A method for fabricating a whit light emitting dioade in which YAG yellow fluorescent material and red fluorescent material are added on a blue LED chip, wherein said red fluorescent material is composed of Eu activated Powellite.

2. The method as in claim 1, wherein said red fluorescent material is CaMoO₄:Eu.

3. The method as in claim 1, wherein a peak value of the light wave of said blue light is 460˜470 nm.
